(19) United States
(12) Patent Application Publication
(10) Pub. No.: US 2014/0326686 A1
(43) Pub. Date: Nov. 6, 2014

(54) SUBSTRATE CARTRIDGE

(71) Applicant: Shenzhen China Star Optoelectronics Technology Co., Ltd., Shenzhen, Guangdong (CN)

(72) Inventors: Chenyangzi Li, Shenzhen City (CN); Chunhao Wu, Shenzhen City (CN); Kunhsien Lin, Shenzhen City (CN); Minghu Qi, Shenzhen City (CN); Yongqiang Wang, Shenzhen City (CN); Zenghong Chen, Shenzhen City (CN); Weibing Yang, Shenzhen City (CN); Yunshao Jiang, Shenzhen City (CN); Zhiyou Shu, Shenzhen City (CN); Guokun Yang, Shenzhen City (CN)

(73) Assignee: Shenzhen China Star Optoelectronics Technology Co., Ltd., Shenzhen, Guangdong (CN)

(21) Appl. No.: 13/979,686

(22) PCT Filed: Jun. 21, 2013
(86) PCT No.: PCT/CN2013/077659

§ 371 Date: Jul. 15, 2013

(30) Foreign Application Priority Data
May 6, 2013 (CN) 201320237955.X

(51) Int. Cl. B65G 49/06

(52) U.S. Cl. CPC B65G 49/061
USPC 211/41.1

(57) ABSTRACT

A substrate cartridge is disclosed. The substrate cartridge includes a cuboid-shaped frame. The cuboid-shaped frame includes a receiving space for carrying a substrate, a first side, a second side parallel to the first side, and a third side connected adjacent to the first side and the second side. The first side and the second side are arranged with lateral supports. The third side is arranged with bottom supports. The bottom support is arranged with bottom branches. The lateral supports and the bottom branches are arranged with supporting portions. The bottom branches expand from the bottom support, and the supporting portions for supporting the substrate are arranged on two opposite ends of the bottom branches. In this way, the distance between the supporting portions of the lateral supports and that of the bottom supports is decreased such that the substrate is prevented from being scratched or fragmented.

This application claims priority to China Patent Application No. 201320237955.X filed on May 6, 2013 entitled, SUBSTRATE CARTRIDGE, all of the disclosures of which are incorporated herein by reference in their entirety.

### BACKGROUND OF THE INVENTION

1. Field of the Invention

Embodiments of the present disclosure relate to liquid crystal display (LCD) manufacturing technology, and more particularly to a substrate cartridge.

2. Discussion of the Related Art

In the LCD manufacturing process, glass substrates are processed and are cut to be in a predetermined size. The cut substrates are loaded by cassettes (CSTs) for further transportation and processes. In order to prevent the glass substrates from being damaged, supporting points for the glass substrates are added.

Referring to FIG. 1, one typical cartridge includes a cuboid-shaped frame 1′ having a receiving space 10′ for carrying a substrate 2′, a first side 11′, a second side 12′ parallel to the first side 11′, and a third side 13′ respectively connects to the first side 11′ and the second side 12′. The first side 11′ and the second side 12′ are respectively arranged with lateral supports 3′, and the third side 13′ is arranged with bottom supports 4′. The lateral supports 3′ and the bottom supports 4′ are arranged with supporting portions 5′, i.e., supporting points, which are made by high-friction material. The substrate 2′ directly contacts with the supporting portions 5′ and is supported cooperatively by the lateral supports 3′ and the bottom supports 4′. The substrate 2′ is received within the receiving space 10′ of the frame 1′.

As shown in FIG. 2, as the gap between the supporting portions 5′ is huge, the substrate 2′ arranged above the supporting portions 5′ may be bent or even deformed. In addition, the substrate 2′ may be shifted during the transportation and thus be damaged.

### SUMMARY

The object of the claimed invention is to provide a substrate cartridge to prevent the substrates from being deformed and damaged.

In one aspect, a substrate cartridge includes: a cuboid-shaped frame includes a receiving space for carrying a substrate, a first side, a second side parallel to the first side, and a third side connected adjacent to the first side and the second side, the first side and the second side are arranged with lateral supports, the third side is arranged with bottom supports, the bottom support is arranged with bottom branches, and the lateral supports and the bottom branches are arranged with supporting portions.

Wherein the third side is arranged with a rear installation rack, a top installation rack and a bottom installation rack, two ends of the rear installation rack respectively connect to the top installation rack and the bottom installation rack, the bottom supports are assembled on the rear installation rack, and the bottom supports are spaced apart and parallel to each other in a vertical direction.

Wherein the bottom branches are arranged on two opposite ends of the bottom supports, the bottom branches are spaced apart and parallel to each other, and the bottom branches are vertical to the bottom supports in the horizontal direction.

Wherein two lateral sides of the bottom supports are provided with a plurality of screw holes, the bottom branch comprises an installation end and a free end, the installation end comprises screw thread corresponding to the screw holes on the bottom supports, and the bottom branches are assembled on the bottom supports by engaging the screw thread with the screw holes.

Wherein the bottom branches are substantially cylinder-shaped tubes or rods, and the supporting portions are arranged on an upward surface of the free ends of the bottom branches.

Wherein the supporting portions are substantially tube-shaped to engage with the free ends of the bottom branches.

Wherein the first side and the second side are arranged with a plurality of installation racks, the installation racks are spaced apart and parallel to each other in the vertical direction, the lateral supports are assembled on the side installation racks, and the lateral supports are spaced apart and parallel to each other in the vertical direction.

Wherein the bottom supports and the lateral supports forms a multi-layer structure in the vertical direction, and the bottom branches and the lateral supports in the same layer are on the same horizontal surface.

Wherein the supporting portions of the bottom branches respectively aligns with the supporting portions of the lateral supports in a horizontal direction.

Wherein the top installation rack and the bottom installation rack are provided with a plurality set of screw holes, two ends of the rear installation rack respectively connects to the top installation rack and the bottom installation rack by screwing the screw into one set of the screw holes.

In another aspect, a substrate cartridge includes: a cuboid-shaped frame includes a receiving space for carrying a substrate, a first side, a second side parallel to the first side, and a third side connected adjacent to the first side and the second side, the first side and the second side are arranged with lateral supports, the third side is arranged with bottom supports, the bottom support is arranged with bottom branches, the lateral supports and the bottom branches are arranged with supporting portions, the third side is arranged with a rear installation rack, a top installation rack and a bottom installation rack, two ends of the rear installation rack respectively connects to the top installation rack and the bottom installation rack, the bottom supports are assembled on the rear installation rack, and the bottom supports are spaced apart and parallel to each other in a vertical direction on the same rear installation rack.

In another aspect, a substrate cartridge includes: a cuboid-shaped frame includes a receiving space for carrying a substrate, a first side, a second side parallel to the first side, and a third side connected adjacent to the first side and the second side, the first side and the second side are arranged with lateral supports that are spaced apart and parallel to each other in a vertical direction, the third side is arranged with bottom supports, the bottom support is arranged with bottom branches, and the lateral supports and the bottom branches are arranged with supporting portions.

### BRIEF DESCRIPTION OF THE DRAWINGS

FIG. 1 is a top view of the typical substrate cartridge.

FIG. 2 is a front view of the typical substrate cartridge.

FIG. 3 is a top view of the substrate cartridge in accordance with one embodiment.

FIG. 4 is a front view of the substrate cartridge in accordance with one embodiment.

FIG. 5 is a three dimensional view of the substrate cartridge in accordance with one embodiment.

FIG. 6 is a schematic view showing the assembly of the bottom support and the frame of the substrate cartridge in accordance with one embodiment.

FIG. 7 is a schematic view showing the assembly of the bottom branches and the bottom support of the substrate cartridge in accordance with one embodiment.

FIG. 8 is a schematic view showing the relationship of the bottom supports and the supporting portions of the substrate cartridge in accordance with one embodiment.

FIG. 9 is a schematic view showing the relationship of the bottom branches and the supporting portions of the substrate cartridge in accordance with another embodiment.

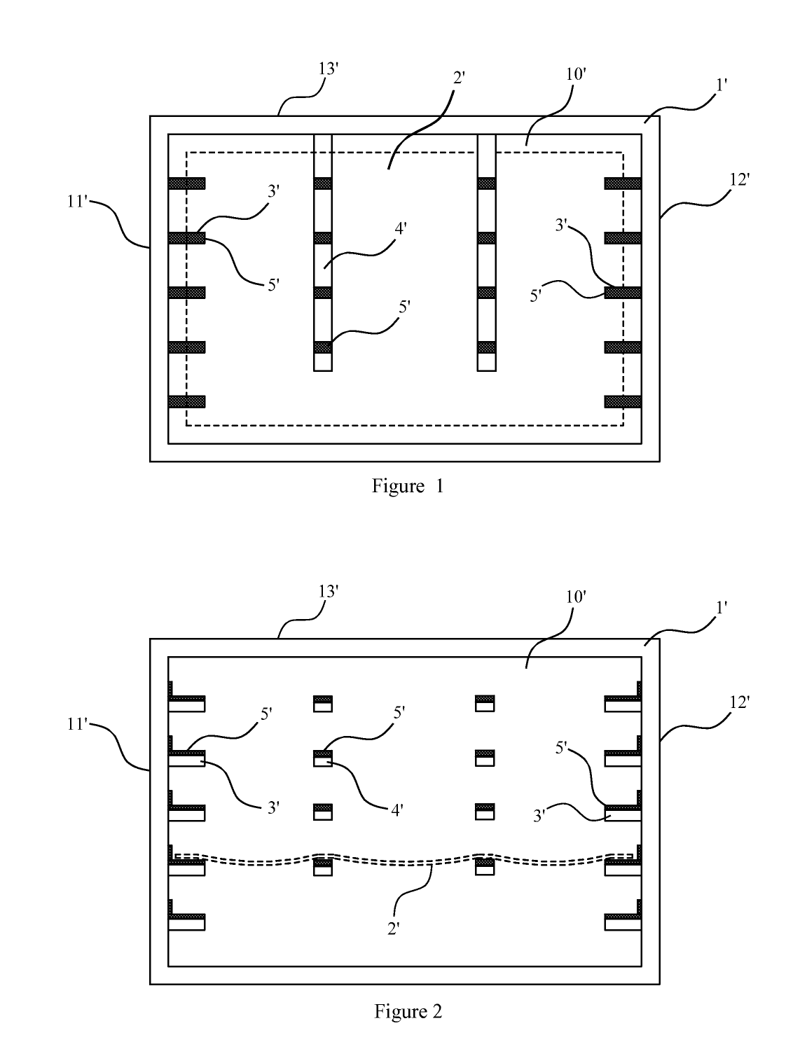

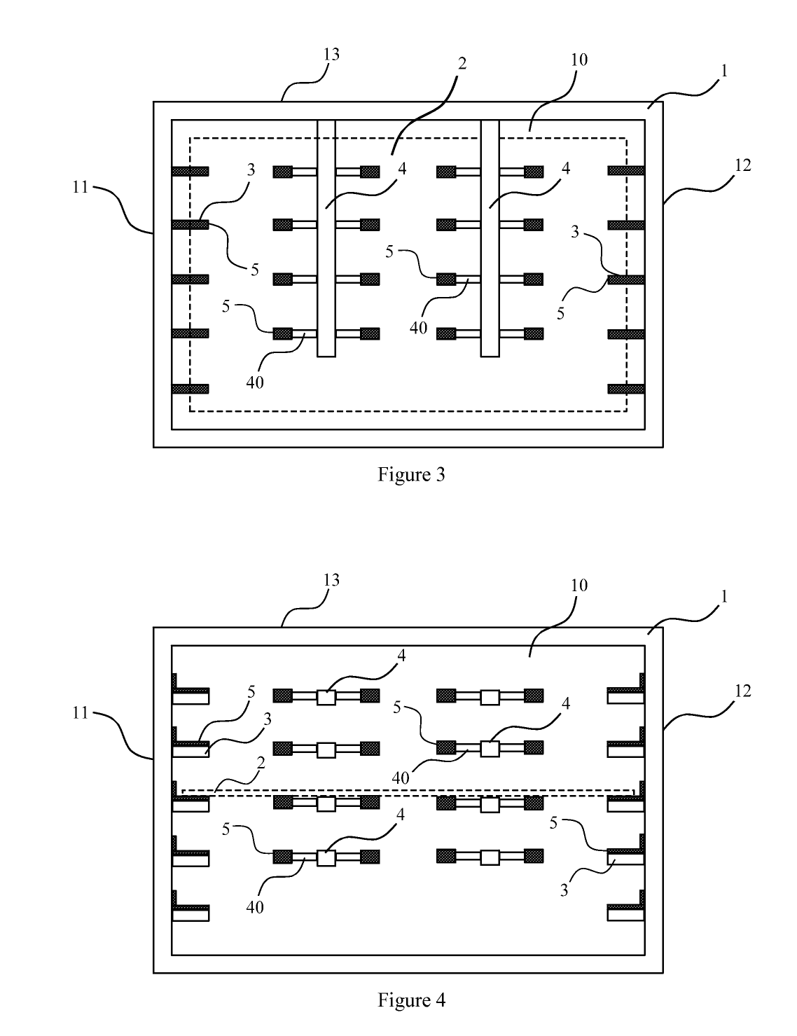

### DETAILED DESCRIPTION OF THE EMBODIMENTS

Embodiments of the invention will now be described more fully hereinafter with reference to the accompanying drawings, in which embodiments of the invention are shown.

FIG. 3 shows a substrate cartridge in accordance with one embodiment. The substrate cartridge includes a cuboid-shaped frame 1 having a receiving space 10 for carrying a substrate 2, a first side 11, a second side 12 parallel to the first side 11, and a third side 13 connected adjacent to the first side 11 and the second side 12. The substrate 2 is indicated by dashed lines in FIG. 3. The substrate 2 may be a glass substrate or a plastic substrate. The first side 11 and the second side 12 are arranged with lateral supports 3. The third side 13 is arranged with bottom supports 4. The lateral supports 3 and the bottom supports 4 are within the receiving space 10. In the embodiment, the bottom support 4 is arranged with bottom branches 40. The lateral supports 3 and the bottom branches 40 are arranged with supporting portions made by high-friction materials. When being loaded, the substrate 2 contacts with the supporting portions 5, and is supported cooperatively by the bottom supports 4 and the bottom branches 40. The substrate 2 is loaded within the receiving space 10.

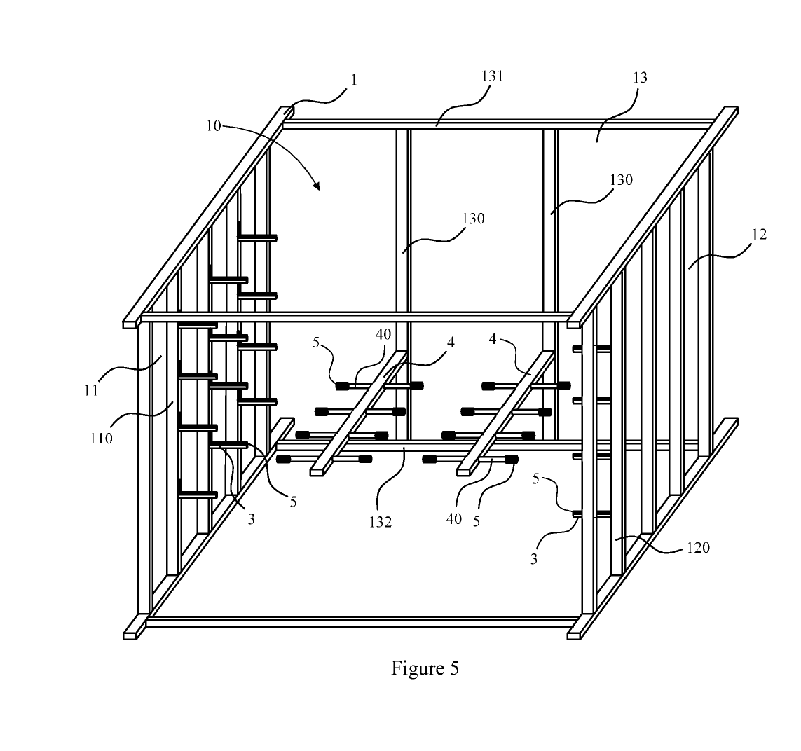

Also referring to FIG. 4, the supporting portions 5 are arranged on two opposite ends of the bottom branches 40. Instead of contacting with the bottom supports 4, the substrate 2 contacts with two opposite ends of the bottom branches 40. In this way, the number of supporting points is increased such that the weight of the substrate is shared among two opposite ends of the bottom branches 40 such that the substrate 2 is prevented from being deformed or shifted, particularly for large-scale substrates. On the other hand, the gap between the supporting portions 5 is reduced and thus the substrate 2 is prevented from being scratched or fragmented due to the bending between two supporting portions 5.

FIG. 5 shows the assembly of the lateral supports 3, the bottom supports 4, and the frame 1. The process of assembling the lateral supports 3 on the first side 11 and on the second side 12 are the same. The process of assembling the lateral supports 3 on the first side 11 will be described hereinafter as an example. A plurality of installation racks 110 are arranged on the first side 11. The installation racks 110 are spaced apart and parallel to each other in a vertical direction. The lateral supports 3 are assembled on the installation racks 110 by screw or latch. As the cartridge is designed for loading multiple-layers substrates, the lateral supports 3 are spaced apart and parallel to each other in the vertical direction. As such, the lateral supports 3 also form the multi-layers structure. It can be understood that the lateral supports 3 on lateral installation racks 120 on the second side 12 are also spaced apart and parallel to each other in the vertical direction. The lateral supports 3 in the same layer are on the same horizontal surface. In addition, the supporting portions 5 arranged on the lateral supports 3 are also on the same horizontal surface. In this way, the substrate 2 can be stably supported without being tilted or lifted up by one of the supporting portions 5.

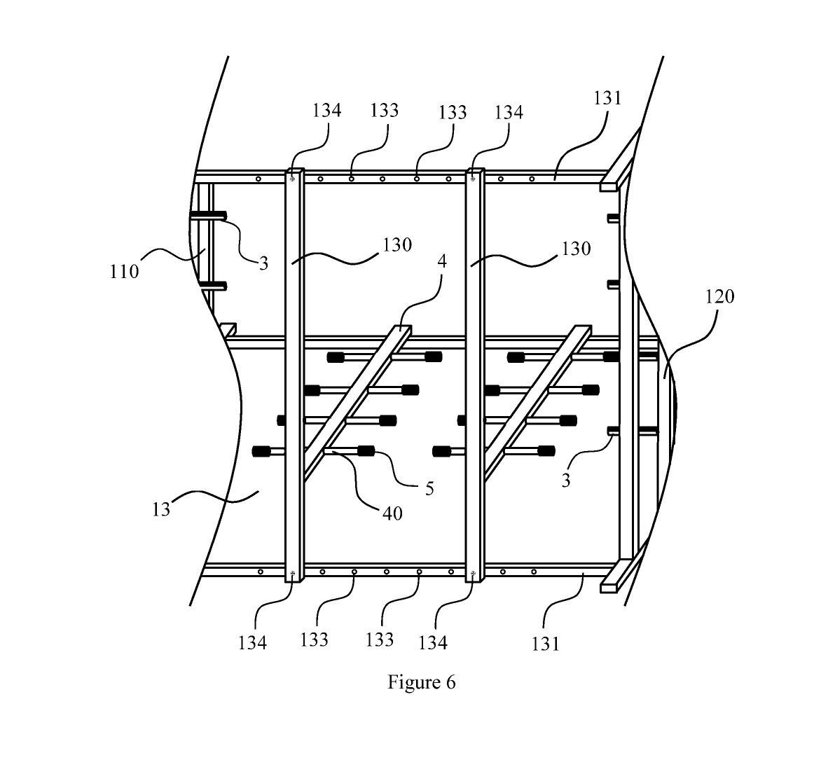

The third side 13 is arranged with a rear installation rack 130, a top installation rack 131 and a bottom installation rack 132. Two ends of the rear installation rack 130 respectively connect to the top installation rack 131 and the bottom installation rack 132. Also referring to FIG. 6, the top installation rack 131 and the bottom installation rack 132 are provided with a plurality set of screw holes 133. One set of the screw holes includes one screw hole on the top installation rack 131 and one corresponding screw hole on the bottom installation rack 132. The rear installation rack 130 is assembled with the top installation rack 131 and the bottom installation rack 132 by screwing the screw into one set of the screw holes. With the plurality set of screw holes, the rear installation rack 130 may be moved in the horizontal direction by dis-assembling the screw and then choosing another set of screw hole. In this way, the distance between the rear installation rack 130 and the first side 11 or the second side 12 may be adjusted.

The bottom supports 4 are assembled on the rear installation rack 130 by ways such as welding. The bottom supports 4 are spaced apart and parallel to each other in the vertical direction on the same rear installation rack 130. To strengthen the support of the bottom supports 4, the bottom supports 4 cannot be moved with respect to the rear installation rack 130 after being assembled.

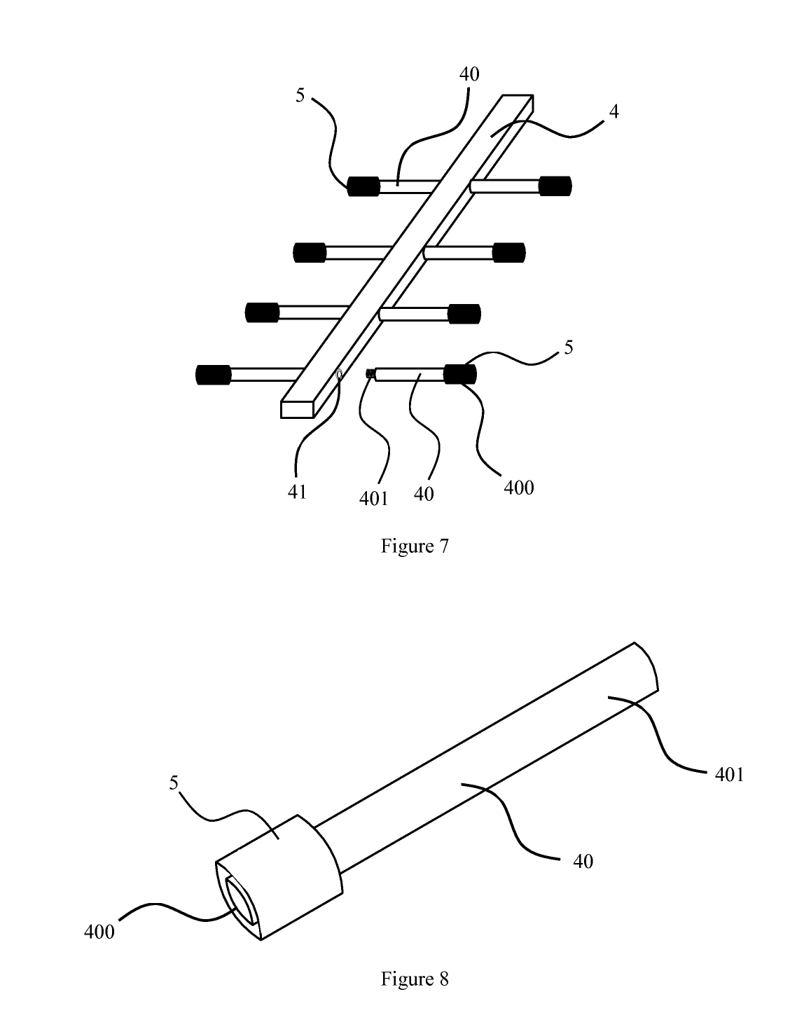

The bottom branches 40 are arranged on two opposite ends of the bottom supports 4. The bottom branches 40 are spaced apart and parallel to each other. The bottom branches 40 are arranged in a fish-bone geometry. To provide a best support, the bottom branches 40 preferably are arranged to be vertical to the bottom supports 4 in the horizontal direction. In the embodiment, the bottom supports 4 are rectangular bars, and the bottom branches 40 are cylinder-shaped tubes or rods. The bottom branches 40 are assembled on the bottom supports 4 by the screws. As shown in FIG. 7, two lateral sides of the bottom supports 4 are provided with a plurality of screw holes 41. The bottom support include an installation end 401 and a free end 400. The installation ends 401 of the bottom branches 40 are provided with corresponding screw thread. By engaging the screw thread with the screw holes on the bottom supports 4, the bottom branches 40 are assembled on the bottom supports 4. Under the circumstance, the bottom branches 40 are isolated from each other and thus can be easily replaced.

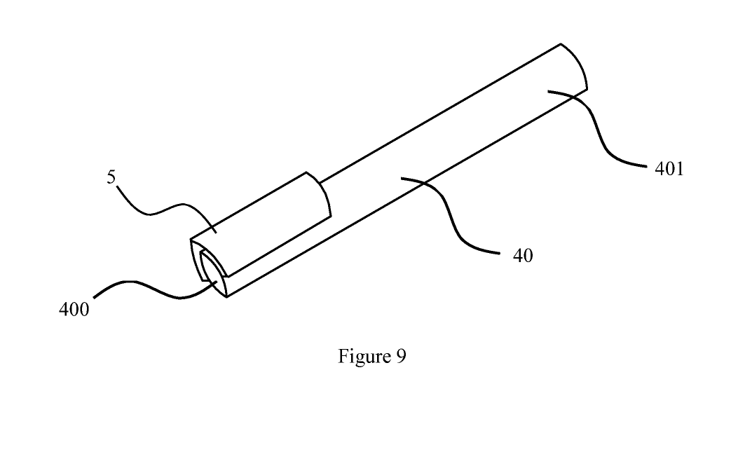

In addition, the free ends 400 of the bottom branches 40 are provided with the supporting portions 5. As shown in FIG. 8, the supporting portions 5 are tube-shaped. The supporting portions 5 engage with the free ends of the bottom branches 40. As the circumference of the free ends 400 are covered by the supporting portions 5, it is unnecessary to consider the locations of the supporting portions 5 for the reason that only the supporting portions 5 contact with the substrate 2. In this way, the assembly efficiency is enhanced. In other embodiments, as shown in FIG. 9, the supporting portions 5 can be arranged only on an upward surface of the free ends 400 so as to reduce the materials needed. Under the circumstance, the screw holes 41 and the screw thread on the installation ends 401 have to be well designed such that the portions covered by the supporting portions 5 face upward. The supporting portions 5 may be made by high-friction materials, such as rubber or silicone, so as to increase the friction between the substrate 2 and the bottom branches 40 or the lateral supports 3. In this way, the substrate 2 is prevented from moving or sliding within the cartridge.

It is to be noted that, as shown in FIG. 4, the supporting portions 5 of the bottom branches 40 and the lateral supports 3 on the same layer are on the same horizontal surface. In addition, as shown in FIG. 3, the supporting portions 5 of the bottom branches 40 respectively aligns with that of the lateral supports 3 on the same layer in a horizontal direction.

It can be understood that the bottom supports 4 moves along with the rear installation rack 130 on the third side 13. In this way, the distance between the supporting portions 5 of the bottom branches 40 and that of the lateral supports 3 is adjusted and thus the cartridge is capable of carrying the substrates 2 of different size. In addition, for large-scale substrates, the supporting points may be increased by adding the bottom supports 4 and the bottom branches 40 of the rear installation rack 130. While the conventional cartridge provides only one supporting portion in the horizontal direction, the cartridge of the claimed invention provides two supporting portions 5 in the horizontal direction without adding another bottom support.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A substrate cartridge, comprising:
a cuboid-shaped frame comprising a receiving space for carrying a substrate, a first side, a second side parallel to the first side, and a third side connected adjacent to the first side and the second side, the first side and the second side are arranged with lateral supports, the third side is arranged with bottom supports, the bottom support is arranged with bottom branches, and the lateral supports and the bottom branches are arranged with supporting portions.

2. The substrate cartridge as claimed in claim 1, wherein the third side is arranged with a rear installation rack, a top installation rack and a bottom installation rack, two ends of the rear installation rack respectively connect to the top installation rack and the bottom installation rack, the bottom supports are assembled on the rear installation rack, and the bottom supports are spaced apart and parallel to each other in a vertical direction.

3. The substrate cartridge as claimed in claim 2, wherein the bottom branches are arranged on two opposite ends of the bottom supports, the bottom branches are spaced apart and parallel to each other, and the bottom branches are vertical to the bottom supports in the horizontal direction.

4. The substrate cartridge as claimed in claim 3, wherein two lateral sides of the bottom supports are provided with a plurality of screw holes, the bottom branch comprises an installation end and a free end, the installation end comprises screw thread corresponding to the screw holes on the bottom supports, and the bottom branches are assembled on the bottom supports by engaging the screw thread with the screw holes.

5. The substrate cartridge as claimed in claim 4, wherein the bottom branches are substantially cylinder-shaped tubes or rods, and the supporting portions are arranged on an upward surface of the free ends of the bottom branches.

6. The substrate cartridge as claimed in claim 4, wherein the supporting portions are substantially tube-shaped to engage with the free ends of the bottom branches.

7. The substrate cartridge as claimed in claim 2, wherein the first side and the second side are arranged with a plurality of installation racks, the installation racks are spaced apart and parallel to each other in the vertical direction, the lateral supports are assembled on the side installation racks, and the lateral supports are spaced apart and parallel to each other in the vertical direction.

8. The substrate cartridge as claimed in claim 7, wherein the bottom supports and the lateral supports forms a multi-layer structure in the vertical direction, and the bottom branches and the lateral supports in the same layer are on the same horizontal surface.

9. The substrate cartridge as claimed in claim 8, wherein the supporting portions of the bottom branches respectively aligns with the supporting portions of the lateral supports in a horizontal direction.

10. The substrate cartridge as claimed in claim 2, wherein the top installation rack and the bottom installation rack are provided with a plurality set of screw holes, two ends of the rear installation rack respectively connects to the top installation rack and the bottom installation rack by screwing the screw into one set of the screw holes.

11. A substrate cartridge, comprising:
a cuboid-shaped frame comprising a receiving space for carrying a substrate, a first side, a second side parallel to the first side, and a third side connected adjacent to the first side and the second side, the first side and the second side are arranged with lateral supports, the third side is arranged with bottom supports, the bottom support is arranged with bottom branches, the lateral supports and the bottom branches are arranged with supporting portions, the third side is arranged with a rear installation rack, a top installation rack and a bottom installation rack, two ends of the rear installation rack respectively connects to the top installation rack and the bottom installation rack, the bottom supports are assembled on the rear installation rack, and the bottom supports are spaced apart and parallel to each other in a vertical direction on the same rear installation rack.

12. A substrate cartridge, comprising:
a cuboid-shaped frame comprising a receiving space for carrying a substrate, a first side, a second side parallel to the first side, and a third side connected adjacent to the first side and the second side, the first side and the second side are arranged with lateral supports that are spaced apart and parallel to each other in a vertical direction, the third side is arranged with bottom supports, the bottom support is arranged with bottom branches, and the lateral supports and the bottom branches are arranged with supporting portions.
